(19) United States
(12) Patent Application Publication
(10) Pub. No.: US 2006/0008124 A1
(43) Pub. Date: Jan. 12, 2006

(54) Iris image-based recognition system

(76) Inventors: Hong Tat Ewe, Selangor Darul Ehsan (MY); Peik Shyan Lee, Selangor Darul Ehsan (MY)

Correspondence Address: BACON & THOMAS, PLLC, 625 SLATERS LANE, FOURTH FLOOR, ALEXANDRIA, VA, 22314, US

(21) Appl. No.: 11/178,454

(22) Filed: Jul. 12, 2005

(30) Foreign Application Priority Data
Jul. 12, 2004 (MY) PI 20042774

(51) Int. Cl. G06K 9/00

(52) U.S. Cl. 382/117

(57) ABSTRACT

The present invention is to identify an individual from his or her iris captured from an imaging system. Basically the system can be divided into two processes, which are enrollment and verification. Each process consists of four steps. Both processes share the three beginning steps, which are image acquisition, image processing, and feature extraction. Image acquisition is to capture the real iris image of a user. Then image processing is applied to the acquired image. In the next step, the textural information of an iris image is generated into a signature in a process called feature extraction. For an enrollment process, the extracted iris signature will be stored in database for the future use of verification. In a verification process, the last step is to compare the iris signature generated from real time processing with the signatures previously stored. A final decision will be made to determine whether the user is successfully identified or not. The present invention introduces two new methods in the iris recognition algorithm. First, a new method called maximum vote finding method that is used during iris image processing was developed to reduce the time required for localization of inner iris after applying Hough Transform for localization of outer iris. Second, an iris signature based on fractal dimension characterization which is a novel approach used in iris feature extraction process was developed to provide satisfactory matching accuracy of iris images.

### FIELD OF INVENTION

The present invention relates to human iris image-based recognition system. More specifically, the present invention relates to maximum vote finding method for reducing the time required for localization of inner iris after applying Hough Transform for localization of outer iris, and further relates to an efficient iris image matching method based on fractal dimension for high accurate iris identification.

### BACKGROUND OF THE INVENTION

Identification of humans is a goal as ancient as humanity itself. As technology and services have developed in the modem world, human activities and transactions have proliferated in which rapid and reliable personal identification is required. Examples include passport control, computer login control, bank automatic teller machines and other transactions authorization, premises access control, and security systems generally. All such identification efforts share the common goals of speed, reliability, and automation.

The use of biometric indicia for identification purposes requires that a particular biometric factor be unique for each individual, that is be readily measured, and that it be invariant over time. Human iris recognition system is one of the biometric technologies that could recognize an individual through the unique features found in the iris of a human eye. The iris of every human eye has a unique texture of high complexity, which proves to be essentially immutable over a person's life. No two irises are identical in texture or detail, even in the same person. As an internal organ of the eye the iris is well protected from the external environment, yet it is easily visible as a colored disk, behind the clear protective window of the eye's cornea, surrounded by the white tissue of the eye. Although the iris stretches and contracts to adjust the size of the pupil in response to light, its detailed texture remains largely unaltered proportionally. The texture can readily be used in analyzing an iris image, to extract and encode an iris signature that appears constant over a wide range of pupillary dilations. The richness, uniqueness, and immutability of iris texture, as well as its external visibility, make the iris suitable for automated and highly reliable personal identification. The registration and identification of the iris can be performed using a camera without any physical contact, automatically and unobtrusively.

The prior art includes various technologies for uniquely identifying an individual person in accordance with an examination of particular attributes of either the person's interior or exterior eye. The earliest attempt is seen in U.S. Pat. No. 4,641,349, issued to two ophthalmologists, Aran Safir and Leornard Florm, in 1987 and entitled “Iris Recognition System” which take advantage of these favorable characteristics of the iris for a personal identification system. Other typical individual identification system such as individual identification system converts the irises textures laid in eye images into irises codes, thus carrying out individual identification by comparing such irises codes. Accordingly, the individual identification system must acquire the position of the irises or the outlines thereof. Different approaches such as integrodifferential operator and two-dimensional Gabor Transform, histogram-based model-fitting method and Laplacian Pyramid technique, zero-crossings of wavelet transform, multi-channel Gabor filtering, circular symmetry filter, two-dimensional multiresolution wavelet transform and two-dimensional Hilbert Transform have also been proposed.

From a practical point of view, there are problems with prior-art iris recognition systems and methods. First, previous approaches to acquiring high quality images of the iris of the eye have: (i) an invasive positioning device serving to bring the subject of interest into a known standard configuration; (ii) a controlled light source providing standardized illumination of the eye, and (iii) an imager serving to capture the positioned and illuminated eye. There are a number of limitations with this standard setup, including: (a) users find the physical contact required for positioning to be unappealing, and (b) the illumination level required by these previous approaches for the capture of good quality, high contrast images can be annoying to the user. Second, previous approaches to localizing the iris in images of the eye have employed parameterized models of the iris. The parameters of these models are iteratively fit to an image of the eye that has been enhanced so as to highlight regions corresponding to the iris boundary. The complexity of the model varies from concentric circles that delimit the inner and outer boundaries of the iris to more elaborate models involving the effects of partially occluding eyelids. The methods used to enhance the iris boundaries include gradient-based edge detection as well as morphological filtering. The chief limitations of these approaches include their need for good initial conditions that serve as seeds for the iterative fitting process as well as extensive computational expense. Third, previous approaches to pattern match a localized iris data image derived from the image of a person attempting to gain access with that of one or more reference localized iris data images on file in a database provide reasonable discrimination between these iris data images, but require extensive computational expense.

In search of improved and more robust algorithm for practical use, the present invention has proposed two new methods which constitute to the key components in the human iris identification and authentication system.

The objective of the present invention is to introduce a new method called maximum vote finding method which helps reducing the time required for localization of inner iris after applying Hough Transform for localization of outer iris.

Another objective of the present invention is to develop an iris image matching method based on fractal dimension which produce high satisfactory matching accuracy of iris images.

The present invention has potential to provide a better human iris identification and authentication system to applications such as online e-commerce where Internet users with web camera can authenticate their identity for e-commerce transactions; m-commerce where modern mobile phones and PDAs (Personal Digital Assistance) with camera can be used for personal identity authentication for m-commerce transactions; and also any authenticated access system for better security.

### SUMMARY OF THE INVENTION

The present invention introduces two new methods in the iris recognition algorithm. First, a new method called maximum vote finding method was developed to reduce the time required for localization of inner iris after applying Hough Transform for localization of outer iris. Second, an iris signature based on fractal dimension characterization is developed which provide satisfactory matching accuracy of iris images.

The invention is to identify an individual from his or her iris captured from an imaging system. Basically the system can be divided into two processes, which are enrollment and verification. Each process consists of four steps. Both processes share the three beginning steps, which are (1) image acquisition, (2) image processing, and (3) feature extraction. Image acquisition is to capture the real iris image of a user. Then image processing is applied to the acquired image. In the next step, the textural information of an iris image is generated into a signature in a process called feature extraction. For an enrollment process, the extracted iris signature will be stored in database for the future use of verification. In a verification process, the last step is to compare the iris signature generated from real time processing with the signatures previously stored. A final decision will be made to determine whether the user is successfully identified or not.

Preferably said maximum vote finding method is used during iris image processing to locate the inner iris boundary which is extracted due to geometrical symmetry of a circle.

Preferably said iris image matching method based on fractal dimension is a novel approach used in iris feature extraction process where iris feature is extracted from the images and these features are represented with the fractal dimensions. Values of fractal dimension are calculated using a predetermined window sizes.

### BRIEF DESCRIPTION OF THE DRAWINGS

FIG. 1 is a block diagram of human iris recognition system architecture.

FIG. 2 is a block diagram showing the steps of image processing.

### DETAILED DESCRIPTION OF THE PREFERRED EMBODIMENTS

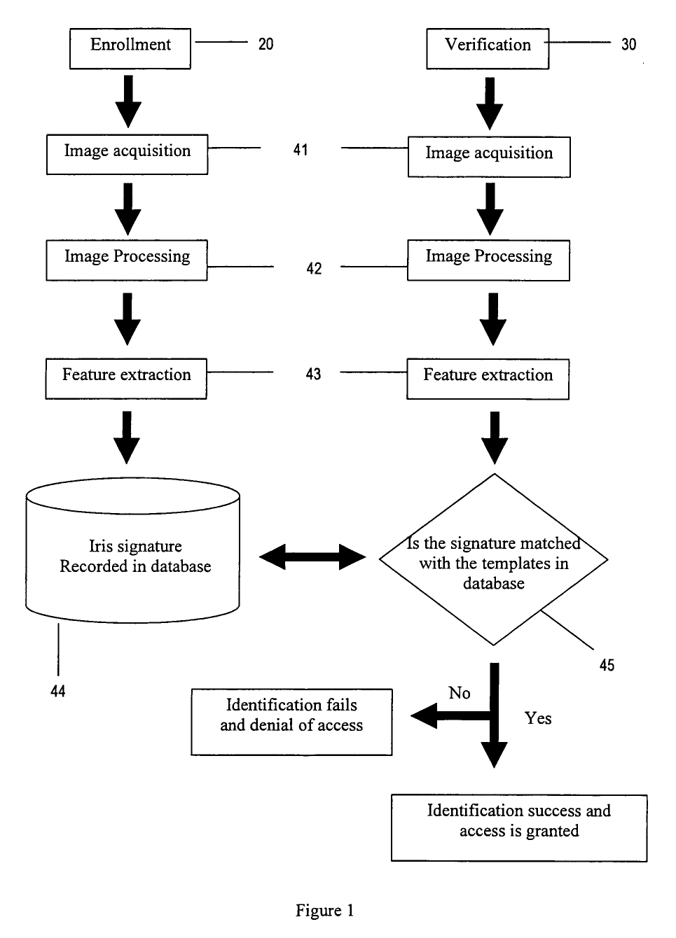

An embodiment of the present invention is shown in schematic form in FIG. 1 and comprises a block diagram depicting the overall architecture of an image-based human iris recognition system. The process will be discussed in overall terms, followed by a detailed analysis.

The iris of the human eye is a complex structure comprising muscle, connective tissue, blood vessels, and chromatophores. Externally it presents a visible texture with both radial and angular variation arising from contraction furrows, collagenous fibers, filaments, serpentine vasculature, rings, crypts, and freckles; taken altogether, these constitute a distinctive “fingerprint”. The magnified optical image of a human iris, thus constitutes a plausible biometric signature for establishing or confirming personal identity. Further properties of the iris that lend themselves to this purpose, and render it potentially superior to fingerprints for automatic identification systems, include the impossibility of surgically modifying its texture without unacceptable risk; its inherent protection and isolation from the physical environment; and its easily monitored physiological response to light. Additional technical advantages over fingerprints for automatic recognition systems include the ease of registering the iris optically without physical contact, and the intrinsic polar geometry of the iris, which imparts a natural coordinate system and origin.

At the broadest level, the present invention is to identify an individual from his or her iris captured from an imaging system. As shown in FIG. 1, basically the system of the present invention can be divided into two processes, which are enrollment (20) and verification (30). Each process consists of four steps. Both processes share the three beginning steps, which are image acquisition (41), image processing (42), and feature extraction (43). Image acquisition (41) is to capture the real iris image of a user. Then image processing (42) is applied to the acquired image. In the next step, the textural information of an iris image is generated into a signature in a process called feature extraction (43). For the enrollment process (20), the extracted iris signature will be stored in database (44) for the future use of verification (30). In a verification process (30), the last step is to compare (45) the iris signature generated from real time processing with the signatures previously stored. A final decision will be made to determine whether the user is successfully identified or not.

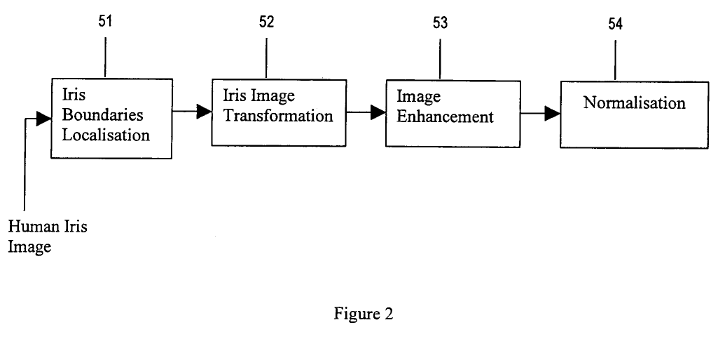

As mentioned above, image processing (42) is applied to the iris image after the iris image of a user is acquired. The first step in processing acquired iris image is to locate the pupillary boundary (inner boundary), separating the pupil from the iris to a high degree of accuracy. This step is critical to insure that identical portions of the iris are assigned identical coordinates every time an image is analyzed, regardless of the degree of pupillary dilation. The inner boundary of the iris, forming the pupil, can be accurately determined by exploiting the fact that the boundary of the pupil is essentially a circular edge. The output of image processing in this system is to segment ROI (region of interest) in the image from its background. In the acquired image, only the information on iris features is needed. Thus, the method used for image processing (42) in the present invention detects the inner (pupillary) and outer (limbus) boundary of an iris. Localising technique (51) is first applied to the acquired image and the localized iris is then transformed (52) from Cartesian coordinate system into Polar coordinate system. Iris image in Polar coordinate system is presented in rectangular form from its original circular shape. Enhancement (53) is also applied to iris image in rectangular form and normalization (54) is the last processing step. FIG. 2 shows the steps involved in processing the iris image. Firstly, a Gaussian filter with predefined sigma value (σ=3.0) is applied to iris images. Then Canny edge detector is applied to the images in order to yield the binary image for input of Hough transform. Hough transform is exploited in locating outer iris boundary. In locating inner iris boundary, maximum vote finding method is used. The inner boundary is extracted due to geometrical symmetry of a circle. The algorithm of maximum vote finding method is described as follows:

Let (xₒ, yₒ) be the center coordinate (calculated from Hough Transform) and rₒ be the radius of the outer circle and vote (xᵢ) is initialized to be zero for all xᵢ,

For m=−rₒ+1 to rₒ−1 do
if there are only 2 feature points detected for row m, excluding the feature points of outer circle then
Set x-coordinate of the right feature point as xᵣ (m) and x-coordinate of the left

$$feature point to {x}_{i} ( m ) for y ( m ) = {y}_{o} + m , \\ Thus , {x}_{i} = \frac{{x}_{r} ( m ) + {x}_{i} ( m )}{2}$$

$$vote ( {x}_{i} ) = vote ( {x}_{i} ) + 1$$

$$end if$$

$$end for$$

The above process is repeated for y-coordinate with varying column values (n) to get vote (yᵢ) xᵢ max=value of vote(xᵢ) with maximum vote for all m yᵢ max=value of vote(yᵢ) with maximum vote for all n

The next step is to find the best estimated radius of inner circle. Let vote(rᵢ) be initialized to zero for all rᵢ.

For p=−rₒ+1 to rₒ−1 do
if there are only 2 feature points detected for row p excluding the feature points of outer circle then
   Set x-coordinate of the right feature point as xᵣ (p) and x-coordinate of the left feature point as xᵢ(p) for y(p)=yₒ+p
      rᵢ={square root over ((xᵢ(p)−x_{i max})²+(y(p)−y_{i max})²)}
   vote (rᵢ)=vote(rᵢ)+1
      rᵢ={square root over ((xᵣ(p)−x_{i max})²+(y(p)−y_{i max})²)}
   vote (rᵢ)=vote(rᵢ)+1
   end if

end for

The above process is repeated for y-coordinate with varying column values (q) to get vote (rᵢ) r_{i max}=value of vote(rᵢ) with maximum vote for all p and q

From the algorithm, the resulted (x_{i max}, y_{i max}) is taken as center coordinate of inner circle and r_{i max} is determined as radius of inner circle.

After iris is located an image, it is then transformed from Cartesian coordinates system into Polar coordinates system. The implementation can be done mathematically as expressed in equation (i).

$$I ( x , y ) -> I ( r , θ ) \\ With I ( {r}_{i} ) = \sqrt{{( {x}_{i} - {x}_{o} )}^{2} + {( {y}_{i} - {y}_{o} )}^{2}} \\ \begin{matrix}I ( {θ}_{i} ) = {sin}^{- 1} \frac{( {y}_{i} - {y}_{o} )}{{r}_{i}} , & if {x}_{i} > {x}_{o} \& {y}_{i} \geq {y}_{o} \\ Π - {sin}^{- 1} \frac{( {y}_{i} - {y}_{o} )}{{r}_{i}} , & if {x}_{i} \leq {x}_{o} \& {y}_{i} > {y}_{o} \\ Π - {sin}^{- 1} \frac{( {y}_{i} - {y}_{o} )}{{r}_{i}} , & if {x}_{i} < {x}_{o} \& {y}_{i} \leq {y}_{o} \\ 2 Π + {sin}^{- 1} \frac{( {y}_{i} - {y}_{o} )}{{r}_{i}} , & if {x}_{i} \geq {x}_{o} \& {y}_{i} < {y}_{o}\end{matrix} \qquad ( i )$$

Iris in a preprocessed image is captured in all size. Due to irregularity of the iris radius for different individual at different time, images in polar representation are varied in dimension. As such, spatial normalization is done to standardize the size of every transformed iris image. Nearest neighborhood technique is chosen and used. After normalization, an iris image in rectangular form with predetermined resolution is produced for example 50×450 resolution. Having accurately defined the image area subject to analysis, the system then proceed to the next step that is processes the data obtained from that area to generate the identification code. The textural information of an iris image is generated into a signature in a process called iris feature extraction (43) as shown in FIG. 1. A novel approach is introduced in the present invention to extract iris feature from the images and represent these feature with the fractal dimensions. The iris signature described in fractal dimension is used in iris recognition. Values of fractal dimension are calculated using predetermined window sizes for example of 11×11 window size. Calculation of values of fractal dimension is described as follow:

The fractal dimension, D, of an object is derived from equation (ii).

$$D = \frac{log ( {N}_{r} )}{log [ 1 / r ]} \qquad ( ii )$$

where D is fractal dimension, Nᵣ is the number of scaled down copies (with linear dimension r) of the original object which is needed to fill up the original object.

By preserving u and v mapping of an image, a third axis (h-axis) is constructed from its gray level value. Values of fractal dimension are calculated for this generated 3D surface within a defined area by the square window in u and v directions. An odd number of window sizes are chosen so that the window can be centered at a particular point and not between points. Window size of 11×11 is defined through experiment.

In a selected window, the value of h for all points in the selected area is normalized as shown below:

$${h}_{n} = h \times \frac{L}{H} \qquad ( iii )$$

where hₙ is the normalized height and H (=255) is the maximum gray level. This normalization is required so that the calculated fractal dimension is within the limit of 3.0 (its topological dimension).

From equation (ii), the calculation of fractal dimension is carried out. One of the methods used to calculate fractal dimension for the image is surface coverage method. In the coverage method, the small square of size 1 unit X I unit is used as the basic measuring unit. Total number of small squares needed to fill up the selected surface within the window, Nᵣ, is calculated, and D is obtained from equation (iii) where r=1/L in this case. The value of D is assigned to the center pixel (uₒ, vₒ) of the windows. The fractal dimensions of other points are obtained by using sliding window technique that moves the current window in u and v direction, and each time the surface bounded by the window is used to calculate the fractal dimension.

In the present invention, for an enrollment process, the extracted iris signature will be stored in database (44) for the future use of verification (30) as shown in FIG. 1.

By referring to FIG. 1, in the verification process (30), the last step is an iris pattern matching process (45) that is to compare the iris signature generated from real time processing with the previously extracted iris signatures stored in database (44) during the feature extraction process (43). A final decision will be made to determine whether the user is successfully identified or not.

For most of the verification process of the prior arts, a similarity metric called a Hamming distance that measures “distance”, or similarity between the two codes is used. The computation of Hamming distance between iris codes is made very simple through the use of the elementary logical operator XOR (Exclusive-OR). Hamming distance simply adds up the total number of times that two corresponding bits in the two iris codes disagree. Expressed as a fraction between 0 and 1, the Hamming distance between any iris code and an exact copy of itself would therefore be 0, since all 2,048 corresponding pairs of bits would agree. The Hamming distance between any iris code and its complement (in which every bit is just reversed) would be 1. The Hamming distance between two random and independent strings of bits would be expected to be 0.5, since any pair of corresponding bits has a 50% likelihood of agreeing and a 50% likelihood of disagreeing. If they arise from the same eye, on different occasions, their Hamming distance would be expected to be considerably lower. If both iris codes were computed from an identical photograph, their Hamming distance should approach zero.

In the present invention, during iris pattern matching process, a modified exclusive-OR operator is designed to measure the disagreement of two irises signature. In previous feature extraction stage, the data for each dimension in iris signature is given in the range of 2.0-3.0 for both analysis methods of Fractal Dimension. As such, the XOR Boolean operator would produce an ‘Agree’ between two comparisons of pixel dimension if the observed value satisfy in the range of value stored in database. Implementation of the operator can be formulated as below:

Let,
FDₒ denotes fractal dimension in observed iris image
FD_{A} denotes fractal dimension in iris image previously stored in database thus the XOR operation of the pair of dimensions would be given as:

$${FD}_{o} ⊗ {FD}_{A} = \{ \begin{matrix}‘ Agree ’ , & if {FD}_{A} - C \leq {FD}_{o} \leq {FD}_{A} + C \\ ‘ Disagree ’ , & else\end{matrix} \qquad ( 8 )$$

where C is a constant to be determined. From the resulted agreement between comparisons of two iris signature, Agreement Ratio (AR) is defined as [iv]:

$$AR = Total number of comparisons for all values in the signature$$

Comparison with calculated AR exceeding threshold will be accepted as successful authentication and matched to be enrolled user in the system. Threshold is determined to pass or fail identification. If the measured AR of comparison is lower than threshold, an imposter is rejected whereas if the measured AR is higher than threshold an enroller user is identified as shown in verification process in FIG. 1.

As described above, the method called maximum vote finding method for localization of inner iris after applying Hough Transform for localization of outer iris according to the present invention has an advantage of reducing the time required for localization. Besides, another method, an iris image matching method based on fractal dimension of the present invention also provides an advantage of producing high satisfactory matching accuracy of iris images.

The present invention provides a better human iris identification and authentication system to applications such as online e-commerce where Internet users with web camera can authenticate their identity for e-commerce transactions; m-commerce where modem mobile phones and PDAs (Personal Digital Assistance) with camera can be used for personal identity authentication for m-commerce transactions; and also any authenticated access system for better security.

It is to be understood that the present invention may be embodied in other specific forms and is not limited to the sole embodiment described above. However modification and equivalents of the disclosed concepts such as those which readily occur to one skilled in the art are intended to be included within the scope of the claims which are appended thereto.

1. A method of identifying an individual by iris image-based recognition system comprising the steps of:
obtaining an iris image of said individual to be identified by locating the outer boundary and the inner boundary of an iris, whereby said inner boundary of said iris is localized using maximum vote finding method;
processing said localized iris image to extract iris features by transforming said localized image into a polar coordinate system;
extracting the characteristic values of fractal dimension from said image area for generating an identification code; and
comparing said characteristic values of said extracted identification code with the characteristic values of a previously stored identification code of said individual.

2. The method of identifying an individual by iris image-based recognition system as claimed in claim 1, wherein said obtaining the iris image comprising the further step of illuminating said iris to acquire said iris image.

3. The method of identifying an individual by iris image-based recognition system as claimed in claim 1, wherein said inner boundary which is the pupillary boundary of said iris is localized by said maximum vote finding method whereby the center coordinate of inner boundary of said iris is defined by (x_{i max}, y_{i max}) and r_{i max} is determined as radius of inner boundary.

4. The method of identifying an individual by iris image-based recognition system as claimed in claim 3, wherein said maximum vote for x-coordinate and y-coordinate of said inner boundary is defined by the following definitions:
$${x}_{i} = \frac{{x}_{r} ( m ) + {x}_{i} ( m )}{2}$$
$$vote ( {x}_{i} ) = vote ( {x}_{i} ) + 1$$
where m=−rₒ+1 to rₒ−1 for example that there are only 2 feature points detected for row m, excluding the feature points of outer boundary and x_{i max}=value of vote(xᵢ) with maximum vote for all m:
$${y}_{i} = \frac{{y}_{r} ( n ) + {y}_{i} ( n )}{2}$$
$$vote ( {y}_{i} ) = vote ( {y}_{i} ) + 1$$
where n=−rₒ+1 to rₒ−1 for example that there are only 2 feature points detected for row n, excluding the feature points of outer boundary and y_{i max}=value of vote(yᵢ) with maximum vote for all n.

5. The method of identifying an individual by iris image-based recognition system as claimed in claim 3, wherein said radius of inner boundary is defined by the following definition:
rᵢ={square root over ((xᵢ(p)−x_{i max})²+(y(p)−y_{i max})²)}
vote (rᵢ)=vote(rᵢ)+1
rᵢ={square root over ((xᵣ(p)−x_{i max})²+(y(p)−y_{i max})²)}
vote (rᵢ)=vote(rᵢ)+1
where p=−rₒ+1 to rₒ−1 for example that there are only 2 feature points detected for row p excluding the feature points of outer boundary, the above process is repeated for y-coordinate with varying column values (q) to get vote (rᵢ) and r_{i max}=value of vote(rᵢ) with maximum vote for all p and q.

6. The method of identifying an individual by iris image-based recognition system as claimed in claim 1, wherein said method further comprising the step of normalizing said transformed iris image to standardize the size.

7. The method of identifying an individual by iris image-based recognition system as claimed in claim 6, wherein said iris image is transformed into polar coordinate system by the relationship:
$$I ( x , y ) -> I ( r , θ )$$
$$With I ( {r}_{i} ) = \sqrt{{( {x}_{i} - {x}_{o} )}^{2} + {( {y}_{i} - {y}_{o} )}^{2}}$$
$$\begin{matrix}I ( {θ}_{i} ) = {sin}^{- 1} \frac{( {y}_{i} - {y}_{o} )}{{r}_{i}} , & if {x}_{i} > {x}_{o} \& {y}_{i} \geq {y}_{o} \\ Π - {sin}^{- 1} \frac{( {y}_{i} - {y}_{o} )}{{r}_{i}} , & if {x}_{i} \leq {x}_{o} \& {y}_{i} > {y}_{o} \\ Π - {sin}^{- 1} \frac{( {y}_{i} - {y}_{o} )}{{r}_{i}} , & if {x}_{i} < {x}_{o} \& {y}_{i} \leq {y}_{o} \\ 2 Π + {sin}^{- 1} \frac{( {y}_{i} - {y}_{o} )}{{r}_{i}} , & if {x}_{i} \geq {x}_{o} \& {y}_{i} < {y}_{o}\end{matrix}$$

8. The method of identifying an individual by iris image-based recognition system as claimed in claim 1, wherein said step of extracting characteristic values is a surface coverage method to calculate fractal dimension for the image and said coverage method further comprising: a predetermined area used as the basic measuring unit;
value of fractal dimension, D, of an object defined by log(Nᵣ)/log [1/r] where Nᵣ is total number of predetermined areas needed to fill up the selected surface within a portion and r equals to 1/L; and
sliding window technique that moves the current portion in u and v direction, and each time the surface bounded by the window is used to obtain the fractal dimensions of such surface.

9. The method of identifying an individual by iris image-based recognition system as claimed in claim 1, wherein said comparing said characteristic values step includes the steps of: measuring the disagreement of two iris identification code that is one previously stored in a database and another produced from real time processing by computing an elementary modified exclusive-OR logical operator; and
comparing said two iris identification code for their Agreement Ratio (AR) which is defined as following definition:
$$AR = Total number of comparisons for all values in the signature ;$$
a threshold to determined pass or fail identification where if the measured AR of comparison is lower than threshold, an imposter is rejected whereas if the measured AR is higher than threshold an enroller user is identified.
